(19) United States
(12) Patent Application Publication
(10) Pub. No.: US 2007/0271170 A1
(43) Pub. Date: Nov. 22, 2007

(54) Methods of transferring seat licenses having certain security features

(75) Inventor: Kyle Burks, The Woodlands, TX (US)

Correspondence Address: Charles Kulkarni;Jackson Walker L.L.P., Suite 2400, 112 E. Pecan Street, San Antonio, TX, 78205-1521, US

(73) Assignee: SEASONTICKETRIGHTS.COM, LLC

(21) Appl. No.: 11/523,851

(22) Filed: Sep. 20, 2006

Related U.S. Application Data
(60) Provisional application No. 60/802,211, filed on May 19, 2006.

(51) Int. Cl. G06Q 40/00

(52) U.S. Cl. 705/37

(57) ABSTRACT

Methods are provided for providing a marketplace for the sale of seat licenses so as to enhance the security of transactions between buyers and sellers, in part, by incorporating certain security features such as verifying seat license title transfers and/or escrowing funds received on behalf of a buyer for the benefit of a seller. Seat licenses may be listed for sale, and bids may be exchanged between sellers and buyers. Upon reaching an agreed price for a seat license, an online marketplace representative may accept funds on behalf of a buyer. These funds may be held in escrow until a seat license title transfer is confirmed. A portion of buyer's funds may be released to the seller after confirmation of the seat license transfer. In this way, the security of seat license buyers and sellers may be enhanced, in part, through the reduction of fraud.

### CROSS-REFERENCE TO RELATED APPLICATION

This application claims benefit of provisional patent application Ser. No. 60/802,211, filed May 19, 2006, the entire disclosure of which is incorporated by reference.

### BACKGROUND

The present subject matter generally relates to a method of providing a marketplace for the sale of seat licenses, and more particularly, to a method of providing a marketplace for the sale of seat licenses incorporating an certain security features so as to ensure the safety of the transaction for each party.

Many sports teams have sold seat licenses to their fans to finance the building of a new stadium, to finance the renovation of a current stadium, or simply to turn over the seat rights to their fans. Seat licenses are present in many sports, including, for example, the NFL, the NBA, the NHL, MLB, NASCAR, and even some college and theatre venues.

Generally, a seat license gives the seat license holder the right to buy season tickets for a certain seat or seats in a stadium. Some seat licenses also give the holder the right to buy tickets for their certain seat for any event that comes to the stadium (e.g. concerts). Other seat licenses only give the seat license holder the right to purchase the right to buy tickets in a particular part of a stadium instead of the right to buy tickets to a particular seat. Typically, fans make a onetime payment for a seat license, the duration of the seat license lasting as long as the team plays in the existing stadium, although some teams limit the duration of their seat licenses for a period of time less than the life of the stadium (e.g. 5 years), after which the seat license holder would have to repurchase the seat license. Depending on the specific seat license, the holder may often sell or transfer the seat license to someone else if they no longer wish to purchase season tickets. If the seat license holder, however, chooses not to sell the seat licenses and does not renew the season tickets, generally, the holder forfeits the license back to the team for no compensation to the holder, although some teams have made their seat licenses refundable after a certain period of time (e.g. 12 years in certain instances). In Europe, seat licenses, which are becoming more popular, are often referred to by the term, “debentures.”

While each team may have certain names, rules, and other differences that apply to their seat licenses, most seat licenses are quite similar. Seat license prices vary by team, with many seat licenses having an average secondary market price of about $2,000 per license.

Each sports team has a certain process that a seat license holder must follow in order to transfer their seat licenses. Often, the current owner of the seat license, i.e. the seller, and the buyer fill out a transfer form and send it to the team for processing. Some teams may have other requirements such as requiring copies of the seller and buyer driver's licenses, notarization of the form, processing fees, etc. These seat licenses transfers often take about 2-3 weeks for the team to process once all the paperwork is received.

The team does not accept payment for the seat licenses, nor are they subject to any agreement between the buyer and seller, nor do they offer any kind of protection to the buyer or seller in the event that either party is defrauded. Since the team does not receive the sales price of the transfer of a seat license, the team does not inquire as to how much the current owner charged the buyer for a seat license. The team's only function is to perform the transfer of the seat license from the seller to the buyer. Some teams will confirm the transfer for the current owner of the seat licenses. Teams may also permit the transfer to occur at the team's ticket office.

Because teams do not buy back seat licenses, current seat license owners who wish to relinquish their season tickets must either sell their seat licenses to a third party or simply forfeit the seat license back to the team for no compensation. Therefore, a secondary market for seat licenses has evolved. In this secondary market, several venues exist that allow sellers to advertise and sell their seat licenses:

Online marketplaces,

Team message boards or other online posting sites, such as Craigslist®

Newspaper ads,

Word of mouth.

Some venues in this secondary market include: eBay®, Paypal®, Seats and Suites, StadiumPSL.com, PhillySBL.com, BaltimoreRavensPSL.com. Some venues, such as StubHub® and TicketsNow®, and Ticket Reserve® are online ticket broker sites. These ticket broker entities do not sell seat licenses, being limited to a market for selling tickets or in some cases, options on tickets or future tickets. Each of these venues suffer from one or more disadvantages, including the lack of sufficient protection against fraud after the transaction. While some online venues have purchase protection programs, seat licenses are often expressly excluded from purchase protection programs, because seat licenses are intangible items.

Thus, no secure method exists to structure seat license transactions to ensure the safety of both parties. Buyers are exposed to significant risk, because of the amounts involved and the fact that sellers normally require payments upfront. On the other hand, sellers are also exposed to significant risk if they wait to collect their funds until after the transfer is completed. The lack of a secure marketplace, the high dollar amount of seat license transactions, and the lengthy 2-3 week process that a transfer normally requires creates a breeding ground for fraud.

### SUMMARY

The present subject matter generally relates to a method for conducting the sale of seat licenses, and more particularly, to a method of providing a marketplace for the sale of seat licenses incorporating certain security features so as to ensure the safety of the transaction for each party.

An example of a method for soliciting and receiving bids for seat licenses comprises the steps of: electronically receiving from a seller a bid request for a seat license; electronically transmitting the bid request for the seat license to a buyer; electronically receiving from the buyer a bid for the seat license, the bid having a bid amount; presenting the bid from the buyer to the seller; electronically receiving an acceptance of the bid by the seller; electronically notifying the buyer of the acceptance of the bid by the seller; electronically accepting funds on behalf of the buyer, the funds corresponding to at least the bid amount from the buyer; escrowing the funds received on behalf of the buyer; confirming a transfer of title of the seat license from the seller to the buyer; and releasing at least a portion of the escrowed funds from the buyer to the seller.

Another example of a method for soliciting and receiving bids for seat licenses comprises the steps of: electronically receiving a desired bid price for a seat license from a seller; electronically transmitting the desired bid price for the seat license to a buyer; electronically receiving an acceptance of the seller's desired bid price from the buyer for the seat license; electronically accepting funds on behalf of the buyer, the funds corresponding to at least the agreed seat license price; escrowing the funds received on behalf of the buyer; confirming a transfer of title of the seat license from the seller to the buyer; and releasing at least a portion of the escrowed funds from the buyer to the seller.

Another example of a method for soliciting and receiving bids for seat licenses, in a computer network, comprises the steps of: electronically receiving a request from a seller for a bid for a seat license; electronically transmitting the request for the bid for the seat license from the seller to a plurality of bidders; electronically receiving a plurality of bids from the plurality of bidders for the seat license; electronically determining a winning bidder, the winning bidder being one of the plurality of bidders who submitted a highest bid among the plurality of bids submitted within a predetermined auction time period; electronically notifying the winning bidder that the winning bidder has submitted a winning bid; electronically accepting funds on behalf of the winning bidder, the funds corresponding to at least the winning bid price; escrowing the funds received on behalf of the winning bidder; confirming a transfer of title of the seat license from the seller to the winning bidder; and releasing at least a portion of the escrowed funds from the winning bidder to the seller.

Yet another example of method for soliciting and receiving bids for seat licenses in an online marketplace comprises the steps of: electronically publishing a listing of a seat license of a seller in the online marketplace; purchasing an option for the seat license from the seller; establishing a price for the option and the seat license with a buyer (This price may be established by the buyer and the representative, or by the buyer and the seller, or by all three.); receiving payment from the buyer wherein the payment is representative of at least the established price; confirming transfer of title of the seat license from the seller to the buyer; and paying the seller for the option

By holding funds in escrow until after the seat license title transfer has been confirmed and/or verifying legal title of the seller, the parties' risk in the transaction is significantly reduced. Additionally, in certain embodiments, verifying the completed transfer with the team, instead of the buyer or the seller, adds another layer of security to the process, because the team is an unbiased third party to the transfer of the seat license.

The features and advantages of the present invention will be apparent to those skilled in the art. While numerous changes may be made by those skilled in the art, such changes are within the spirit of the invention.

### BRIEF DESCRIPTION OF THE FIGURES

A more complete understanding of the present disclosure and advantages thereof may be acquired by referring to the following description taken in conjunction with the accompanying figures, wherein:

FIG. 1A shows a flowchart illustrating an example of a method for transferring seat licenses incorporating an escrow feature wherein a seller accepts a buyer's bid.

FIG. 1B shows a flowchart illustrating an example of a method for transferring seat licenses incorporating certain verification steps wherein a seller accepts a buyer's bid

FIG. 2 shows a flowchart illustrating an example of a method for transferring seat licenses wherein a buyer accepts a seller's bid.

FIG. 3 shows a flowchart illustrating an example of a method for transferring seat licenses including an auction-type marketplace that occurs, at least partially, via a computer network in accordance with one embodiment of the present invention.

FIG. 4 shows a flowchart illustrating an example of a method for transferring seat licenses, incorporating the use of options as part of seat license transactions.

While the present invention is susceptible to various modifications and alternative forms, specific exemplary embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE PREFERRED EMBODIMENTS

By providing a marketplace for the sale of seat licenses combined with certain features such as confirming transfer of seat license titles along with verification and/or escrow features for buyer's funds, the methods of the present invention provide additional protection against fraudulent seat license transactions. One example of a method for transferring seat licenses comprises the following steps:

A seller lists a seat license or seat licenses for sale on an online marketplace,

The seller and a buyer agree on a price for the seat license,

The buyer pays the agreed price plus a fee to a representative of an online marketplace,

The online marketplace representative escrows the buyer's funds until transfer of the seat license can be verified,

The online marketplace representative verifies with the team or the seat license administrator that the seat license transfer is complete and accurate, and

The online marketplace representative causes the funds to be issued, less a fee, to the seller.

In this way, the process adds additional protection to the seller, because an online marketplace representative verifies and holds the funds from the buyer until the seat license title transfer takes place. The escrow feature also ensures the seller will receive the promised funds. Additionally, this process protects the buyer, because the online marketplace representative verifies with the team or seat license administrator that the transfer is complete before issuing the funds to the seller. Accordingly, this verification ensures the buyer will receive the seat license or alternatively, that the buyer will receive a refund of their funds. Furthermore, because an online marketplace representative verifies the completed title transfer with the team, as opposed to the buyer or seller, this verification adds another layer of security to the process, since the team is essentially an unbiased third party to the transfer.

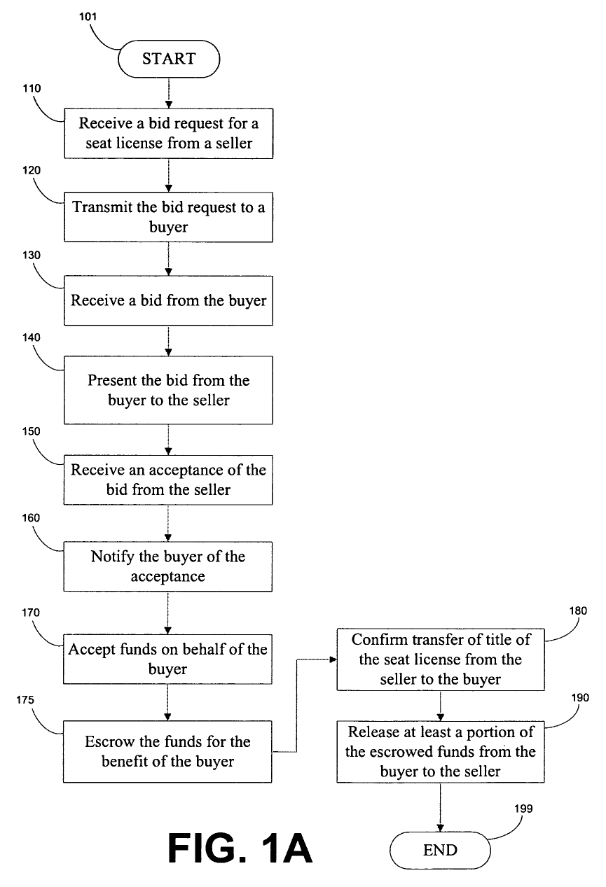

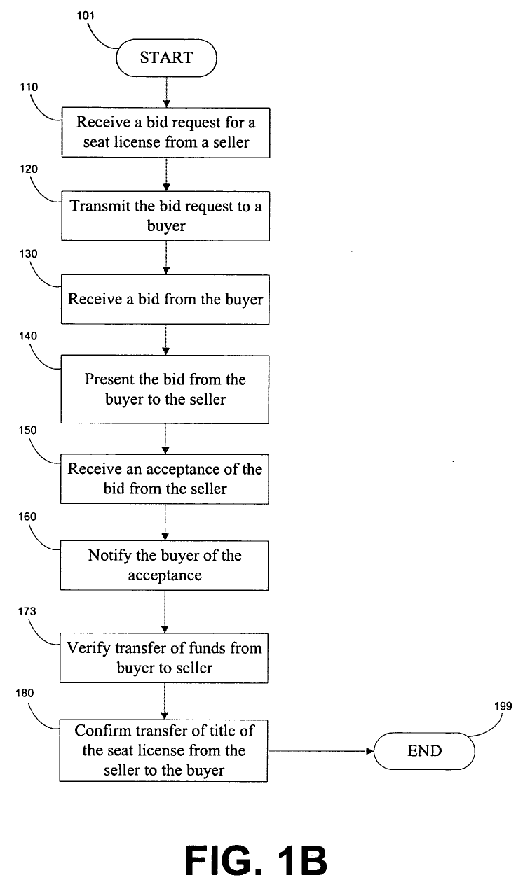

One example of a method for transferring seat licenses is illustrated in FIG. 1A. While the marketplace of the invention need not occur over the Internet, in one preferred embodiment, the marketplace is provided via a web site that presents a common place for buyers and sellers to interact. Those skilled in the art will appreciate that although these methods may be discussed herein in the context of a web site and/or Internet context, it is expressly recognized that these methods are not restricted to such a context. The methods described herein may take place via stand-alone kiosks, networked cell phones, PDAs, ATMs, and other devices capable of performing the methods of the present invention.

In those embodiments where the method is carried out by use of an online marketplace, the seller may optionally create an account on the online marketplace to list their seat license(s) for sale. To create an account, a seller may input their contact information, their name and address, and a username and password to login to their account.

A seller lists a seat license for sale as depicted in step 110 of FIG. 1. Each listing may be given a unique listing number or other unique identifier. While each listing is for a seat license or licenses, it may also include a parking pass, partial or full payment of the season tickets, and/or the tangible season tickets if the seller already has them in hand. Each listing may be associated with additional information regarding the seat license, which may include the following items of information: the number of seats, the relevant section(s), the relevant row(s), whether a parking pass is included, the printed price on ticket, a total asking price, a low seat number, a high seat number, whether the price is negotiable, the nearest section to the seat(s), the season parking price, the amount already paid on the following year's tickets, the remaining balance on the following year's tickets, the due date on any remaining balance, the status of the following year's tickets, other parking pass details, if any, such as, the parking pass color or lot, and other relevant notes.

In step 120, the bid request is electronically transmitted to one or more buyers. In the context of a web-based marketplace, this electronic transmission may be by way of a buyer “browsing” the web-based marketplace to view available seat license listings.

The online marketplace may be configured so as to categorize the seat licenses for sale by team with each team's page showing custom or team-specific information relating to the particular team's seat licenses and/or the team's transfer process.

Optionally, the online marketplace may be configured to allow buyers to create an account to bid on seller seat licenses. The account may be configured to permit buyers to input, among other information, their contact information, any desired information relating to the seat license for sale, and a username and password to login to their account.

In step 130, a buyer transmits a bid for a listing. That is, when a buyer sees a desired listing, the buyer can submit an offer to the seller through the online marketplace. The offer may simply consist of the total amount the buyer is willing to pay for the listing. The online marketplace could additionally be configured to calculate and display to the buyer, a total amount, which may include the seat license listing price along with any transfer fee, team transfer fee, or other additional applicable fees. For example, one way of determining a transfer fee could be by charging $200 or 3% of the offer amount, whichever is greater. In this case, the total amount due to the buyer would be the sum of the offer amount and the applicable transfer fee. Alternatively, the transfer fee, the team transfer fee, and any of the additional fees could be assessed to the seller or to the buyer as desired. The term, “transfer fee,” as used herein, refers to the fee charged by the online marketplace. The term, “team transfer fee,” by contrast, refers to the fee, if any, payable to the team or team administrator for the administrative cost of effecting a seat license title transfer.

Notifications may be sent to the buyer and seller as each of the steps in the process is completed to advise them of the status of the transaction and to prompt them for further action as necessary. In some cases, these notifications may be in the form of by e-mail, by text message, by web page, or by other communication methods.

After a bid is submitted by a buyer, the seller may be presented with the buyer's bid as illustrated in step 140. In certain embodiments, the seller may be permitted to respond to an offer by logging into their online marketplace account, if one exists. Three examples of suitable ways that a seller could respond to the offer are as follows:

1) The seller could let the offer can expire,
For example, the seller could be given a time period, such as 48 hours to respond before the offer expires.

2) The seller could reject the offer,
When rejecting the offer, the seller could be permitted to make a counteroffer. Then, if the buyer were to choose to make another offer to the seller, the buyer would know what amount the seller desires. In this instance, the counteroffer could simply be for informational purposes only, not permitting the buyer to take any action on the counteroffer or alternatively, the buyer could be permitted to accept the seller's counteroffer.

3) The seller could accept the offer.

In certain embodiments, the step of electronically allowing the seller to accept the bid at an agreed price from the buyer may be automatic based upon a preauthorized acceptance requiring no further action by the seller beyond an earlier designation of a requested bid price. After receiving seller's acceptance of buyer's bid in step 150, the buyer is sent notification of seller's acceptance as indicated in step 160. Again, these notifications may be in the form of an e-mail, text messages, by transmission of web pages, or other communication methods.

In certain embodiments, after the seller accepts the offer, the online marketplace is automatically disposed to accept transfer of the buyer's funds corresponding to at least the agreed price plus any transfer fee and/or other applicable fees as shown in step 180. In this embodiment, the online marketplace representative will not accept a buyer's funds until a particular condition such as acceptance is satisfied. Funds may be released or transferred in a variety of suitable formats and methods including wire transfer, electronic funds transfer, cashier's check, credit card, debit card, personal check, or any combination thereof.

If desired, the contact information of the seller and buyer may optionally be hidden or withheld from one another. By not sharing this information between the two parties at this point, sales initiated at the online marketplace but completed outside of the online marketplace may be avoided, thus reducing the opportunities for parties to avoid paying an agreed transfer fee to the online marketplace representative.

After receipt and verification of buyer's funds in step 170, the funds or a portion thereof are held in escrow for the benefit of the buyer as illustrated in step 175. The term “escrowing funds,” as used herein, refers to holding or designating funds or a portion thereof for the benefit of a buyer. This term does not necessarily imply that the online marketplace representative transfers the funds or a portion thereof to be held by another third party.

The parties may then take steps to complete transfer of title of the seat license from the seller to the buyer. At this point, the contact information of the buyer and seller may be shared as necessary among the parties to aid in effectuating the transfer of seat license title. Some teams require the buyer and seller to complete a transfer form. In this case, the team may send a contract to the buyer to fill out and return. After the transfer form is completed and received, the buyer's name may be officially designated on the account and no further action by the seller would be required to effect the seat license title transfer.

Alternatively, in lieu of the seller and the buyer effecting the seat license title transfer themselves, each party may authorize the online marketplace representative to act on each party's behalf through a limited power of attorney form or other suitable legal instrument necessary to effect title transfer of the seat license.

However the seat license title is transferred, the title transfer of the seat license is verified by the online marketplace representative as shown in step 180. The verification could be by some type of written communication. Alternatively, the verification may simply be a telephone call by the online marketplace representative to the team's ticket office to verify that the seat licenses are now in the name of the buyer. If the team's ticket office will not verify this information, such as for privacy reasons, a conference call may be placed with the seller and the team to verify this information. In another embodiment, the online marketplace representative could simply verify with both the buyer and seller that the transfer is completed, thus avoiding the necessity of calling the team to verify the title transfer. This process may also be automated. In one embodiment, both the seller and the buyer could be permitted to signal that the title transfer has been validly completed by communicating this fact directly to the online marketplace representative or at the online marketplace web site.

After verifying the transfer, a portion of the funds held in escrow may be issued to or released to the buyer, less any transfer fee or other applicable fees as depicted in step 175. Funds transfers may be by a variety of suitable formats and methods including wire transfer, electronic funds transfer, cashier's check, credit card, debit card, personal check, or any combination thereof.

FIG. 1B illustrates another example of a method for transferring seat licenses, incorporating certain verification security features. Steps 110 to 160 proceed as described in FIG. 1. After step 160, however, the online marketplace representative confirms a transfer of funds from the buyer to the seller as illustrated in step 173. The buyer pays the seller directly and then, the buyer, the seller, or both send a proof of payment to the online marketplace representative to verify the completion of the payment. The verification of payment directly from the buyer to the seller serves the security function of the escrow system described above. In such a system, if desired, the online marketplace representative could accept credit card numbers from both the buyer and the seller to permit the credit cards to be charged/credited to correct any later discovered underpayments or overcharges. In step 180, the seat license title transferred may be confirmed as described above. The method ends at step 199.

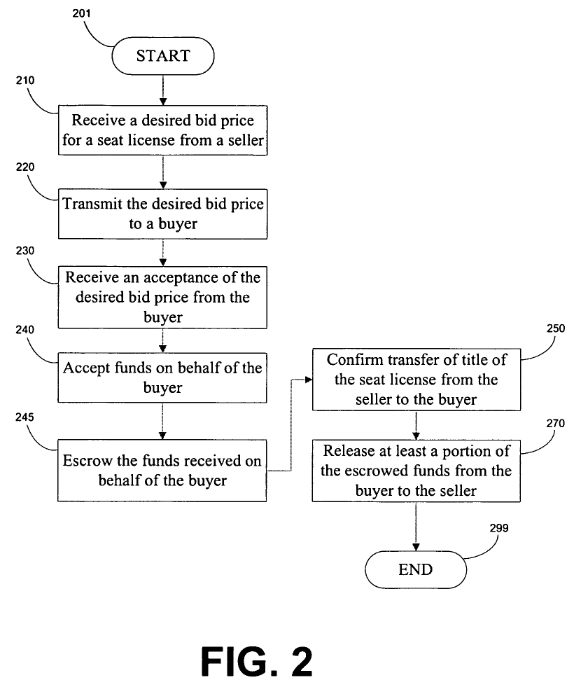

FIG. 2 shows a flowchart illustrating another example of a method for transferring seat licenses in accordance with another embodiment of the present invention. Whereas FIG. 1A and FIG. 1B illustrated an embodiment in which the seller accepted an offer by the buyer, FIG. 2 illustrates an embodiment in which the buyer accepts an offer by the seller.

A seller may request a bid price for a seat license as shown in step 210. In step 220, the desired bid price is electronically transmitted to one or more buyers. Again, in the context of a web-based marketplace, this electronic transmission may be by way of a buyer “browsing” the web-based marketplace to view available seat license listings.

The online marketplace representative then receives an acceptance of seller's bid at an agreed price from the buyer, as illustrated in step 230. In certain embodiments, the step of electronically receiving an acceptance of the desired bid price from the buyer may be automated, such as by a preauthorized acceptance. In such a case, no further action by the buyer beyond an earlier designation of a requested bid price is necessary. The online marketplace representative may accept funds on behalf of the buyer for the agreed price, plus any transfer fee, team transfer fee, or other additional applicable fees as illustrated in step 240. In step 245, the funds or at least a portion thereof are escrowed for the benefit of the buyer. In step 250, the seat license title transfer is confirmed. In step 270, at least a portion of buyer's funds are transferred or released to the seller.

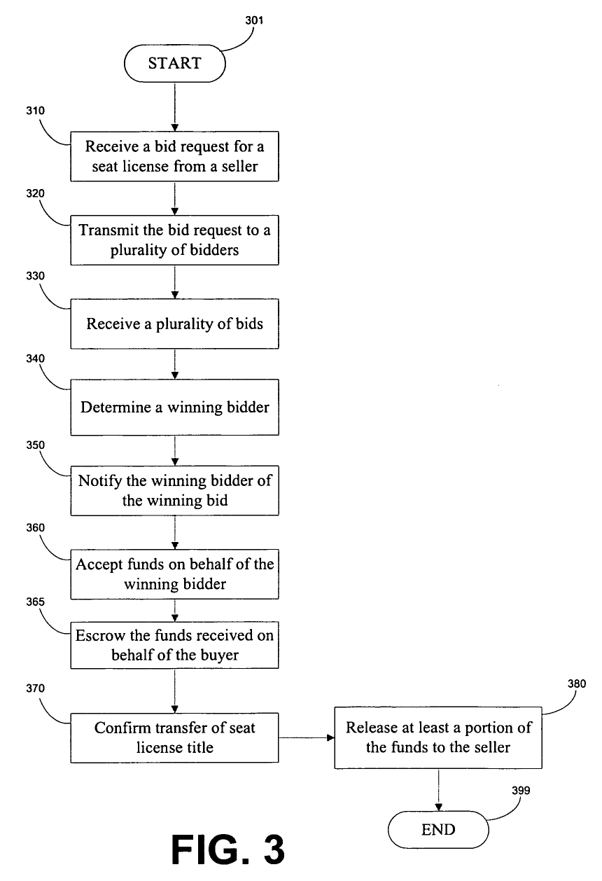

FIG. 3 shows a flowchart illustrating an example of a method for transferring seat licenses via an auction-type marketplace that occurs, at least partially, via a computer network in accordance with one embodiment of the present invention. The seller may list a seat license for bids in an auction-type marketplace, as in step 310. Steps 320 to 350 illustrate a typical auction bidding process in which bidders are permitted to submit bids for a seat license for a time period defined by a fixed duration of time, by a predetermined event, or by the actuation of some conditional event. Alternatively, a seller could list a seat license at a “Buy It Now®” price, wherein the seller specifies a pre-designated fixed bid price at which the sale would conclude. In certain embodiments, the seller may specify a pre-designated fixed bid price wherein the auction would prematurely end should the pre-designated fixed bid price be reached in the auction.

In step 360, funds are accepted on behalf of the winning bidder and held in escrow pending completion of the transaction as shown in step 365. As illustrated in step 370, transfer of the seat license title is then confirmed in the manner described in the embodiments herein. Finally, at least a portion of the buyer's funds are transferred or released to the seller, as shown in step 380.

Some teams also allow transfers of club lease agreements and season ticket accounts. Although the owner of the lease or account may not own an official seat license, if the team allows them to transfer it to a non-related third party, then they inherently have a “pseudo seat license” that they could sell. The term, “seat license,” as used herein, expressly includes pseudo seat licenses and any transferable license, option, or other right to acquire tickets for a seat or seats. If the team only allows the owner to transfer the lease or account to an immediate family member or relative, or if they do not allow them to transfer it at all, then the owner would not have a transferable asset or “pseudo seat license.” Additionally, some leagues have sold seat licenses that pertain to a particular event (e.g. the MLS All Star Game and the MLS championship game), regardless of the stadium the event is played in. The term “seat license” expressly includes this type of seat license as well.

Further, the buying and selling of club lease agreements could also be secured by using the same verification and/or escrow methods described herein. Additionally, it is expressly recognized that the online marketplace representative could verify seller's ownership of the seat license at any point in the methods herein described to provide additional assurance to the buyer that the seller is the true owner of the seat license to be sold. The online marketplace representative could, for example, verify the seller's seat license title before permitting the seller to list the seat license for sale in the seat license marketplace.

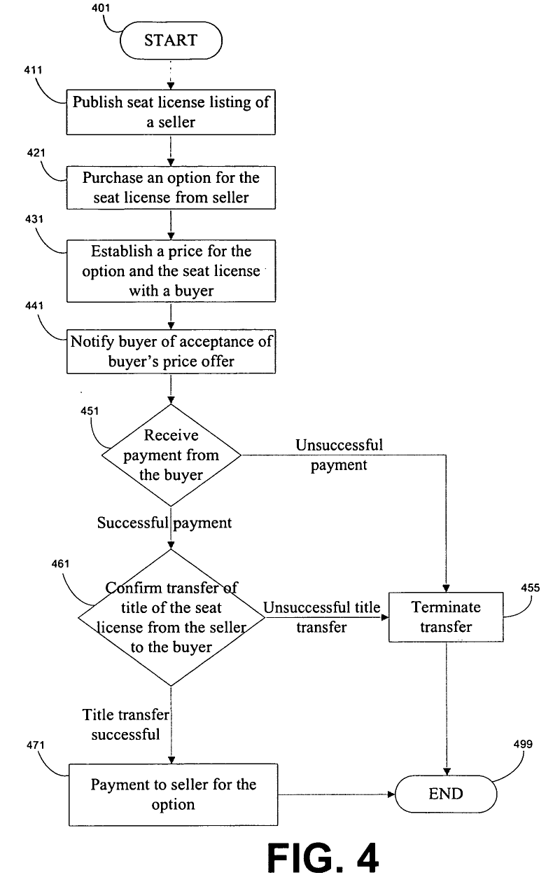

FIG. 4 shows a flowchart illustrating an example of a method for transferring seat licenses, incorporating the use of options to purchase seat licenses. In certain embodiments, it may be desirable for the online marketplace representative to obtain an option to purchase a seat license from the seat license seller as part of a seat license transaction. Among other advantages, obtaining an option to purchase a seat license can give the online marketplace representative additional alternatives such as the ability to sell the seat license to another entity should a seat license transaction between a buyer and a seller not be successfully completed.

A seat license listing of a seller may be published as explained above and illustrated in step 411. An option to purchase the seat license is created by agreement between the seller and the online marketplace representative as illustrated in step 421. In this embodiment, the seller agrees to give the online marketplace representative an option to purchase the seat license upon requesting a seat license listing. In step 431, the seller and/or the online marketplace representative establish a price for the option and the seat license with a buyer by agreement. Thus, an agreed price is determined at which the transfer of the seat license should occur.

In step 441, the buyer is notified of the acceptance of buyer's price offer.

In step 451, the online marketplace representative receives a payment from the buyer corresponding to the established price plus any transfer fee and/or other applicable fees. If the fund transfer is successful, the transfer of the seat license title from the seller to the buyer is confirmed as illustrated in step 461. If the payment from the buyer or verification thereof fails for any reason, the method may terminate as shown via step 455. In the event that the transaction between the buyer and the seller does not successfully complete as desired, the online marketplace representative may exercise its option for seller's seat license. By exercising the option, the online marketplace representative has the flexibility to continue to sell seller's seat license to other entities without the participation of the buyer.

If the confirmation of the transfer of seat license title is successful in step 461, then the online marketplace representative pays the seller for the option at price corresponding to the earlier established price. If the confirmation of the title transfer from seller to buyer in step 461 is unable to be completed, the method may terminate via step 455, in which case, the online marketplace representative again has the choice of exercising the seat license option.

Although certain embodiments herein anticipate that the online marketplace representative performs the steps of the method, the online marketplace representative may choose to outsource web server hosting, web server, escrow services, payment processing, title verification, and/or other steps of the methods described herein to an outside company on behalf of the online marketplace representative. In certain embodiments, even though some of these steps may be outsourced to a third party on behalf of the online marketplace representative, the service to users would be provided so that the users would not normally be aware that the online marketplace representative was not actually operating the product directly. Furthermore, guarantees and/or warranties could be given to the extent desired to guarantee the transfer of the seat licenses, an amount paid on a seat license, a parking pass, tangible tickets, and/or the overall security of the transactions.

One or more methods of the present invention may be implemented via an information handling system. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU or processor) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display.

While the specification has been described in detail with respect to specific embodiments of the invention, it will be appreciated that those skilled in the art, upon attaining an understanding of the foregoing, may readily conceive of alterations to, variations of, and equivalents to these embodiments. Unless otherwise stated, the method steps herein are not limited to a particular order. These and other modifications and variations to the present invention may be practiced by those of ordinary skill in the art, without departing from the spirit and scope of the present invention. Furthermore, those of ordinary skill in the art will appreciate that the foregoing description is by way of example only, and is not intended to limit the invention.

What is claimed is:

1. A method for soliciting and receiving bids for seat licenses comprising the steps of:
(a) electronically receiving from a seller a bid request for a seat license;
(b) electronically transmitting the bid request for the seat license to a buyer;
(c) electronically receiving from the buyer a bid for the seat license, the bid having a bid amount;
(d) presenting the bid from the buyer to the seller;
(e) electronically receiving an acceptance of the bid by the seller;
(f) electronically notifying the buyer of the acceptance of the bid by the seller;
(g) electronically accepting funds on behalf of the buyer, the funds corresponding to at least the bid amount from the buyer;
(h) escrowing the funds received on behalf of the buyer;
(i) confirming a transfer of title of the seat license from the seller to the buyer; and
(j) releasing at least a portion of the escrowed funds from the buyer to the seller.

2. The method of claim 1 further comprising the step of verifying that the seller holds a valid title to the seat license anytime before step (b).

3. The method of claim 1 wherein step (e) is automatic and based upon a preauthorized acceptance requiring no further action by the seller beyond an earlier designation of a requested bid price.

4. The method of claim 1 wherein step (f) occurs by an e-mail notification.

5. The method of claim 1 wherein step (f) occurs by electronically transmitting the acceptance of the bid by the seller via a web page.

6. The method of claim 1 wherein the request from the seller further comprises seat license information wherein the seat license information is a seat location, a seat license account number, an inclusion of a parking pass, an inclusion of season tickets, or any combination thereof.

7. The method of claim 1 wherein step (g) occurs by a wire transfer, an electronic funds transfer, a credit card payment, a debit card payment, or a combination thereof.

8. The method of claim 1 wherein step (j) occurs by a wire transfer, an electronic funds transfer, a credit card payment, a electronic debit card payment, or a combination thereof.

9. The method of claim 1 wherein steps (a)-(g) are performed on a web-based computer network system.

10. The method of claim 9 wherein step (h) is performed on a web-based computer network system.

11. A method for soliciting and receiving bids for seat licenses comprising the steps of:
(a) electronically receiving a desired bid price for a seat license from a seller;
(b) electronically transmitting the desired bid price for the seat license to a buyer;
(c) electronically receiving an acceptance of the seller's desired bid price from the buyer for the seat license;
(d) electronically accepting funds on behalf of the buyer, the funds corresponding to at least the agreed seat license price;
(e) escrowing the funds received on behalf of the buyer;
(f) confirming a transfer of title of the seat license from the seller to the buyer; and
(g) releasing at least a portion of the escrowed funds from the buyer to the seller.

12. The method of claim 11 wherein step (c) is automatic and based upon a preauthorized acceptance requiring no further action by the buyer beyond an earlier designation of a requested bid price.

13. The method of claim 11 wherein steps (d) and (g) occur by a wire transfer, an electronic funds transfer, a credit card payment, a debit card payment, or a combination thereof.

14. The method of claim 11 wherein steps (a)-(c) are performed on a web-based computer network system.

15. The method of claim 14 wherein step (d) is performed on a web-based computer network system.

16. A method for soliciting and receiving bids for seat licenses, in a computer network, comprising the steps of:
(a) electronically receiving a request from a seller for a bid for a seat license;
(b) electronically transmitting the request for the bid for the seat license from the seller to a plurality of bidders;
(c) electronically receiving a plurality of bids from the plurality of bidders for the seat license;
(d) electronically determining a winning bidder, the winning bidder being one of the plurality of bidders who submitted a highest bid among the plurality of bids submitted within a predetermined auction time period;
(e) electronically notifying the winning bidder that the winning bidder has submitted a winning bid;
(f) electronically accepting funds on behalf of the winning bidder, the funds corresponding to at least the winning bid price;
(g) escrowing the funds received on behalf of the winning bidder;
(h) confirming a transfer of title of the seat license from the seller to the winning bidder; and
(i) releasing at least a portion of the escrowed funds from the winning bidder to the seller.

17. The method of claim 16 wherein the highest bid is limited by a pre-designated fixed bid price specified by the seller, so that the winning bidder would be one of the plurality of bidders that submitted a bid corresponding to pre-designated fixed bid price.

18. The method of claim 16 wherein steps (a)-(f) are performed on a web-based computer network system.

19. A method for soliciting and receiving bids for seat licenses in an online marketplace comprising the steps of:
(a) electronically publishing a listing of a seat license of a seller in the online marketplace;
(b) purchasing an option for the seat license from the seller;
(c) establishing a price for the option and the seat license with a buyer;
(d) receiving payment from the buyer wherein the payment is representative of at least the established price;
(e) confirming transfer of title of the seat license from the seller to the buyer; and
(f) paying the seller for the option.
